(19) United States
(12) Patent Application Publication
(10) Pub. No.: US 2003/0220848 A1
(43) Pub. Date: Nov. 27, 2003

(54) Method and apparatus for accessing and tracking customer information and ordering product

(75) Inventor: Brett Behrendt, Petoskey, MI (US)

Correspondence Address: FOLEY AND LARDNER, SUITE 500, 3000 K STREET NW, WASHINGTON, DC, 20007, US

(73) Assignee: MICHIGAN MEDICAL & DENTAL

(21) Appl. No.: 10/151,883

(22) Filed: May 22, 2002

(51) Int. Cl. G06F 17/60

(52) U.S. Cl. 705/28; 705/26

(57) ABSTRACT

A customer data collection system for product delivery from a supplier is provided comprising an information manager for accessing a product ordering history record and entering a purchase order, each purchase order including customer information, selected product information, and delivery information. The delivery information comprises one of an end customer location, an order placer location, and a predetermined delivery location other than the end customer location and the order placer location.

### BACKGROUND OF THE INVENTION

I. Field of the Invention

The present invention relates generally to the field of customer data collection systems for product delivery to a customer from a supplier, and more particularly, to a customer data collection system including a portable information manager (PIM) for loading or accessing customer information such as a customer identifier, order filling information, and previous order history information.

II. Background of the Invention

Customer data collection systems are often used for performing various inventory control functions and inventory ordering functions in a variety of environments, including grocery stores, department stores, and manufacturing parts supply. A conventional system may use identification devices such as barcode labels which are scanned in as various products are delivered to a loading dock at the customer's location to aid in performing the inventory control functions and inventory ordering functions. These conventional systems, however, suffer from many disadvantages.

One disadvantage with many conventional systems is that they do not provide for automatic ordering of supplies. Thus, in many systems, a manual check of the inventory must be performed, and an order placed by telephone to a supplier who delivers the goods at some later date.

Another disadvantage with conventional systems is that they do not provide for a selectable delivery location or delivery method. For example, many systems do not allow an order placer to chose to deliver ordered product(s) to an end user (e.g., a grocery store) or to the order placer (e.g., a distributor). Thus, the order placer in conventional systems typically must be the customer to whom the product is being delivered. This requires duplicative ordering and unnecessary delays in product delivery, as the end customer must place an order with the distributor, and the distributor in turn must place an order with the vendor/supplier (e.g., a manufacturing plant). Frequently, there will be additional delays due to the time lag between when the end customer places his customer order and the distributor reads the order and places his distributor order with the vendor. Additional transportation and delivery costs may also occur, as the distributor needlessly has to receive the goods and re-ship them to the end customer.

Another disadvantage with conventional systems is that they do not provide sufficient order history information on a per customer basis. Thus, in the case of supplying medical supplies (e.g., prescription medication, bandages, etc.) to a patient, for example, the order history information (e.g., the patient's treatment history) cannot be used to accurately track what medical supplies are needed for the patient's treatment. Thus, the wrong medical supplies may be ordered, and/or the patient's current supply of medical supplies may run out before a new order is placed or delivered.

Hence, a need exists for an improved customer data collection system for product delivery to a customer from a supplier.

### SUMMARY OF THE INVENTION

The present invention is directed at reducing or eliminating one or more of the problems set forth above, and other problems found within the prior art.

According to one aspect of the present invention, a customer data collection system for product delivery from a supplier is provided comprising an information manager for accessing a product ordering history, record and entering a purchase order, each purchase order including customer information, selected product information, and delivery information. The delivery information comprises one of an end customer location, an order placer location, and a predetermined delivery location other than the end customer location and the order placer location.

According to another aspect of the present invention, a method of ordering product for customer delivery from a vendor using an information manager is provided comprising the steps of accessing a product ordering history record, placing a purchase order, selecting a delivery address, and shipping the product from the vendor to the selected delivery address. The delivery address is selected from one of an end customer delivery address, an order placer delivery address, and a delivery location other than the end customer location and the order placer location.

According to another aspect of the present invention, a program product is provided for causing an information manager to perform the method steps of accessing a product order history record, placing a purchase order, entering a delivery address, and shipping the product from the vendor to the entered delivery address. The delivery address is selected from one of an end customer delivery address, an order placer delivery address, and a delivery location other than the end customer location and the order placer location.

### BRIEF DESCRIPTION OF THE DRAWINGS

The invention is described in more detail below on the basis of exemplary embodiments, referring to the drawings in which:

FIG. 1 is a block diagram of a customer data collection system according to an embodiment of the present invention;

FIG. 2 is a block diagram of another customer data collection system according to an embodiment of the present invention; and

FIG. 3 is a flow chart of a method of ordering product for customer delivery according to an embodiment of the present invention.

### DETAILED DESCRIPTION OF THE PREFERRED EMBODIMENTS

Reference will now be made in detail to presently preferred embodiments of the present invention. Wherever possible, the same reference numbers will be used throughout the drawings to refer to the same or like parts.

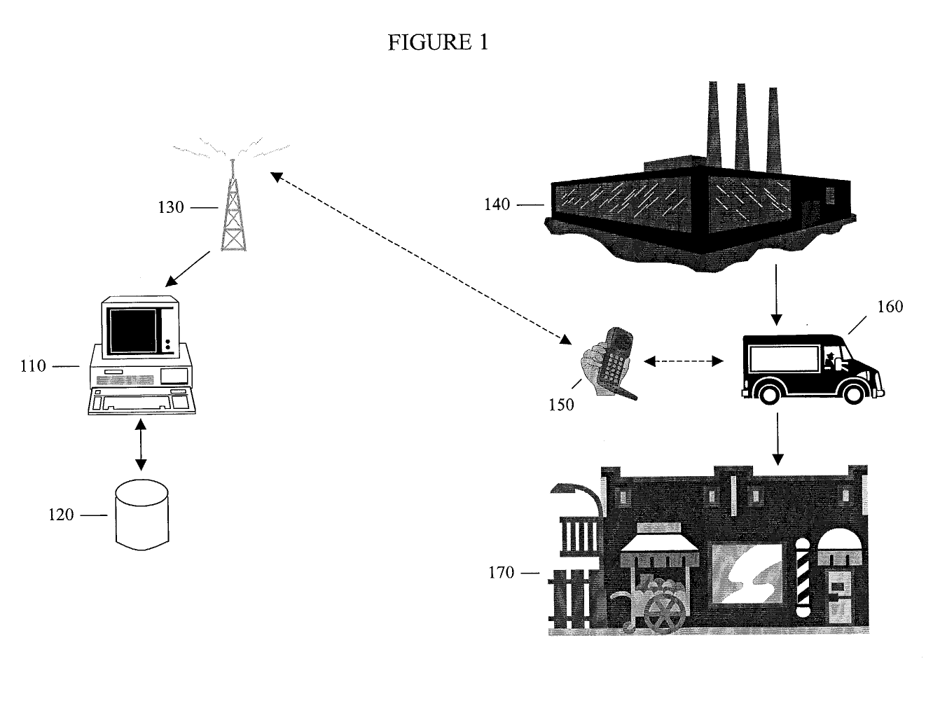

A first embodiment of a customer data collection system according to the present invention is shown in the block diagram of FIG. 1. A database 120 is provided including at least a customer list, a product catalog, and a product ordering history record (preferably for each customer). By way of example, but not by way of limitation, one such database 120 for supplying goods to retail stores 170 (e.g., grocery stores, department stores, automobile dealerships, etc.), may include a list of retail stores 170, a corresponding product catalog of retail goods (e.g., foodstuff, clothing, parts, office supplies, etc.), and a product ordering history record for each retail store 170. Preferably, the product ordering history record includes a listing of what products a specific retail store 170 supplies (i.e., a store inventory list), how much of a given product is in inventory at the retail store 170, and how often the retail store 170 orders new stock. An exemplary order placement will be described in detail below.

According to this first embodiment, a retail store 170 is restocked by a vendor/supplier 140 (e.g., a manufacturer, distributor, a wholesaler, etc.). A driver 160 (e.g., a Frito Lay Driver) routinely visits the retail store 170, and may be provided with a portable information manager (PIM) 150 (e.g., a portable electronic device such as a Palm Pilot or Cassiopeia loaded with appropriate inventory management and ordering software) for loading or accessing customer information such as a customer identifier, order filling information, and previous order history information. Order filling information preferably includes scheduling information (e.g., time to deliver, time until present inventory depleted, etc.), delivery information (e.g., delivery carrier, delivery address, special instructions such as fragile goods or refrigeration required, etc.), and/or other order filling information as would be readily apparent to one of ordinary skill in the art after reading this disclosure.

At small retail stores (e.g., gas station mini-marts, 7-11 stores, etc.), the driver 160 typically stocks the shelves for the store 170 on arrival, and enters purchase orders into the PIM 150 for needed product. Thus, in the case of small retail stores, the driver 160 typically delivers ordered product directly to the end customer (e.g., the retail store 170).

At larger retail stores (e.g., supermarkets such as Super Walmart and Meijers), however, the driver 160 simply takes an inventory check of what product is needed (i.e., does not deliver ordered product to the retail store), and enters purchase orders into the PIM 150 for needed product. The inventory is usually delivered and stocked by the larger retail store's own distribution center, typically a central distribution center which stocks many of that particular customer's retail stores. Thus, in the case of larger retail stores, the vendor/supplier 140 may deliver product to a distributor, rather than to the end customer directly.

Alternatively, ordered product may be delivered to a predetermined location other than the retail store 170 or the distributor, such as to a warehouse. Other possible arrangements are also possible, as would be readily apparent to one of ordinary skill in the art after reading this disclosure.

When the driver returns to his base station at the end of the day from his appointed rounds, he synchronizes the PIM 150 with server 110, which maintains the database 120. Synchronization transfers the order information and inventory update to the server 110 for updating the database 120 accordingly. Preferably, the PIM 150 synchronizes with server 110 by transmitting a wireless signal (e.g., an infrared, microwave or radio signal) to antenna 130 electronically coupled to server 110. Alternatively, the PIM 150 may synchronize with server 110 by a direct connection, and/or other communication scheme. Synchronization with server may be done automatically whenever an order is placed and/or an inventory is updated if desired.

Orders (typically including part number, part quantity, customer delivery information, and/or basic end customer demographics) are then sent from the server 110 to the vendor/supplier 140 for processing and delivery. Alternatively, the PIM 150 may synchronize directly with the vendor/supplier 140, and thus place the order directly with the vendor/supplier 140 rather than requiring the server 110 to send the order to the vendor/supplier 140.

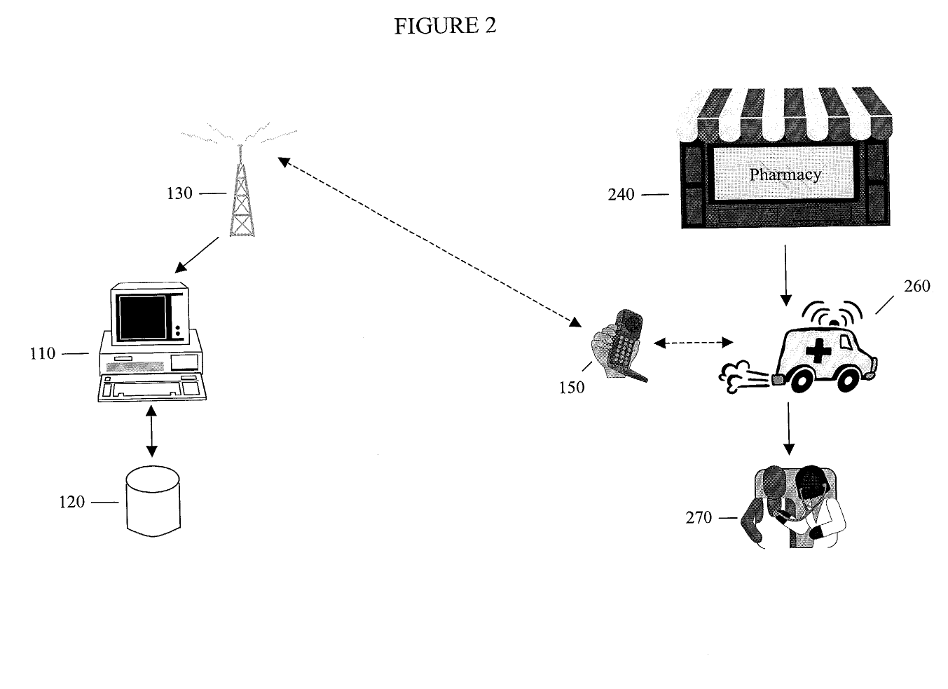

A second embodiment of a customer data collection system according to the present invention is shown in the block diagram of FIG. 2. As noted above with respect to the first embodiment, database 120 is provided including a customer list, a product catalog, and a product ordering history record (preferably for each customer). By way of example, but not by way of limitation, one such database 120 for supplying goods to medical customers 270 (e.g., hospital patients, senior citizens, physician offices, dentist offices, ophthalmologists, etc.), may include a list of medical customers 270, a corresponding product catalog of medical supplies (e.g., prescription medication, over the counter medication, bandages, therapeutic devices, etc.), and a product ordering history record for each medical customer 270. Preferably, the product ordering history record for a given patient includes a listing of what medical supplies are used in the treatment of that patient, how much of a given product is in inventory at the patient's location (e.g., a hospital, private residence, doctor's office, etc.), and how often the patient orders new stock (e.g., how long a given prescription lasts before a refill is required). An exemplary order placement will be described in detail below.

According to this second embodiment, a medical customer 270 places orders to a pharmacy or distributor 240 for restocking inventory at the medical customer's 270 location. A driver 260 (e.g., a drug store delivery service) visits the medical customer 270, and may be provided with a PIM 150 for loading or accessing customer information such as a customer identifier, order filling information, and previous order history information. The order placement and supply then corresponds to a similar scheme as previously described with respect to a first embodiment of the present invention.

Alternatively, the driver 260 may instead be a nurse performing her daily rounds in a hospital or doctor's office. The nurse uses the PIM 150 during her day to keep track of assigned medical goods for the patients (e.g., medical customers 270) and medical supplies on hand at the doctor's office, hospital, retirement community or other medical facility.

When the nurse finishes her appointed rounds, she synchronizes the PIM 150 with server 110 which maintains the database 120. The PIM may be synchronized with the server 110 as set forth above with respect to a first embodiment of the present invention. The nurse may select one of several different delivery locations for a purchase order. For example, the nurse may select to have medical supplies (e.g. prescriptions) delivered from a pharmacy 240 to a medical customer 270 (e.g., a patent) at that medical customer's 270 location (e.g., a residence). Alternatively, the nurse may select to have medical supplies (e.g., tongue depressors, bandages, etc.) delivered to the doctor's office directly to re-stock supplies at the doctor's office used in the treatment of the patient. Furthermore, the nurse may select to have medical supplies (e.g., prescription drugs) delivered to a predetermined delivery location other than the medical customer 270's location (e.g., a outside care provider central office for a retirement community). Other possible scenarios are also plausible, as would be readily apparent to one of ordinary skill in the art after reading this disclosure.

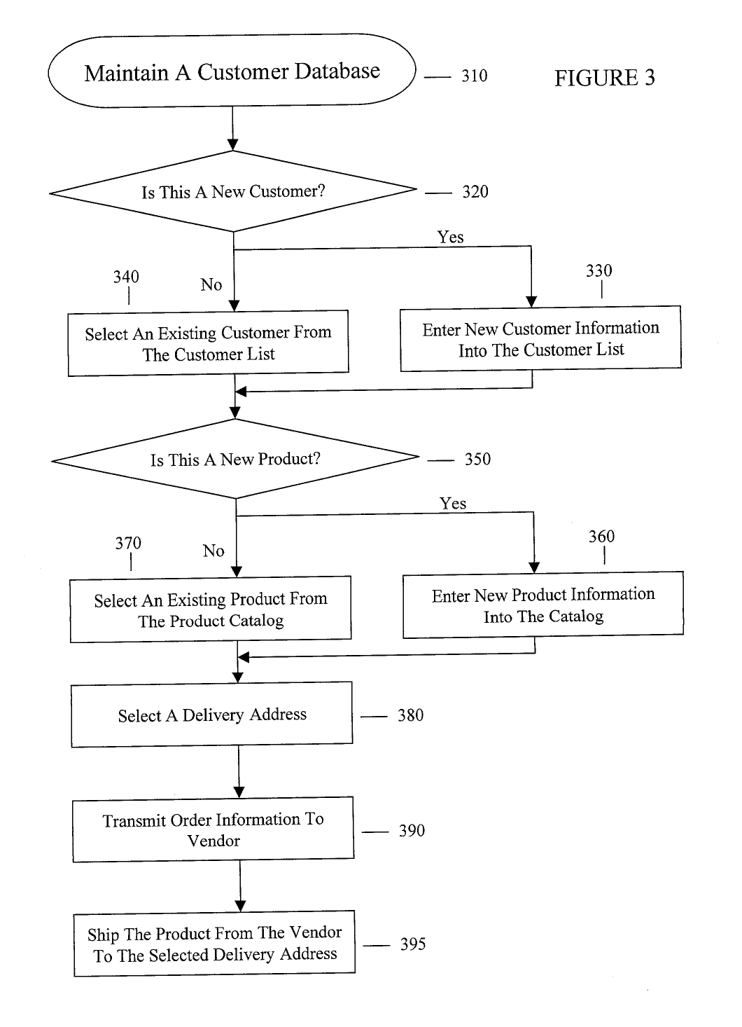

A third embodiment of the present invention is shown in the flow chart of FIG. 3. In step 310 (and preferably continuously throughout) a customer database is maintained. The customer database preferably includes a customer list, a product catalog, and a product ordering history record for each customer on the list. An order is placed on a PIM by first selecting whether the order placer is a new customer in step 320. If an existing customer is selected in step 340, substantially no new customer information is required. However, if the order placer is a new customer, customer information (e.g., customer demographics, payment information, inventory management features, etc.) is entered into the customer list in step 330.

The order placer then determines whether or not the product to be ordered is a new product in step 350. If an existing product is selected in step 370, the order placer proceeds to step 380. However, if a new product is to be ordered, product information (e.g., available suppliers, product description, product price, shelf life, etc.) is entered into the product catalog in step 360. Alternatively, the order place may simply update an inventory amount in step 350. The PIM or server may then automatically determine whether a product needs to be ordered (e.g., by comparing the updated inventory amount to a predetermined minimum inventory level) and an amount to be ordered if that product is available in different quantities.

The order placer then selects a delivery address in step 380. This step may be performed automatically or by default as part of selecting an existing customer from the customer list in step 340, if the selected customer typically has product shipped to a predetermined location. Preferably, the order placer selects one of an end customer delivery address, an order placer delivery address, and a delivery address other than the end customer delivery address and the order placer delivery address. Preferably, the delivery address other than the end customer delivery address and the order placer delivery address is predetermined.

The order is then transmitted to the vendor in step 390. Step 390 may be performed by transmitting the order to the vendor automatically via a wireless connection as soon as the order is placed in a PIM. Alternatively, orders may be uploaded to the vendor at a predetermined time interval(s), such as when a delivery driver returns to a base station and synchronizes with a server at the base station. The product is then shipped from the vendor/supplier in step 395 to the delivery address selected in step 380.

The aforementioned method steps may also provide additional features, as would be readily apparent to one of ordinary skill in the art after reading this disclosure. For example, existing customers may be removed from the customer list after a predetermined time interval has expired from a last placed order, as part of maintaining a customer database in step 310. Other variations and/or additions are also within the scope of this invention.

It should be noted that although the flow chart(s) provided herein show a specific order of method steps, it is understood that the order of these steps may differ from what is depicted. Also two or more steps may be performed concurrently or with partial concurrence. Such variation will depend on the software and hardware systems chosen, which is generally considered a matter of designer choice. It is understood that all such variations are within the scope of the invention. Likewise, software and web implementation of the present invention could be accomplished with standard programming techniques with rule based logic and other logic to accomplish the various database searching steps, correlation steps, comparison steps and decision steps.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed is:

1. A customer data collection system for product delivery from a supplier, comprising:
an information manager for accessing a product ordering history record and entering a purchase order, each purchase order including customer information, selected product information, and delivery information,
wherein said delivery information comprises one of:
an end customer location;
an order placer location; and
a predetermined delivery location other than said end customer location and said order placer location.

2. The customer data collection system of claim 1, wherein said information manager comprises a portable information manager device.

3. The customer data collection system of claim 2, further comprising a server for receiving said purchase order, wherein said portable information manager device transmits purchase orders to said server.

4. The customer data collection system of claim 3, wherein said portable information manager device automatically transmits purchase orders to said server via a wireless connection.

5. The customer data collection system of claim 1, further comprising a customer database including:
a customer list;
a product catalog; and
said product ordering history record.

6. The customer data collection system of claim 5, wherein said customer list comprises a list of medical patients, said product catalog comprises a catalog of medical supplies, and said product ordering history record comprises medical supplies used in the treatment of each patient.

7. The customer data collection system of claim 5, wherein said customer list comprises a list of retail stores, said product catalog comprises a catalog of retail goods, and said product ordering history record comprises a list of retail goods stocked by each retail store.

8. The customer data collection system of claim 5, wherein a customer is taken off said customer list after a predetermined time period from a last placed order by said customer expires.

9. The customer data collection system of claim 5, wherein a new customer is added to said customer list when an order is entered for a customer not already included on said list.

10. The customer data collection system of claim 1, wherein the order placer is one of an end customer, a distributor, and a manufacturer.

11. A method of ordering product for customer delivery from a vendor using an information manager comprising the steps of:
accessing a product ordering history record;
placing a purchase order;
selecting a delivery address from one of an end customer delivery address, an order placer delivery address, and a delivery location other than said end customer location and said order placer location; and
shipping said product from said vendor to said selected delivery address.

12. The method of claim 11, further comprising maintaining a customer database, said database including:
a customer list;
a product catalog; and
said product ordering history record.

13. The method of claim 12, wherein placing a purchase order includes the steps of:
entering a new customer into said database if said customer is not already on said customer list;
selecting a customer from said customer list if said customer has previously ordered product from said vendor; and
selecting a product from said product catalog.

14. The method of claim 12, wherein said customer list comprises a list of medical patients, said product catalog comprises a catalog of medical supplies, and said product ordering history record comprises medical supplies used in the treatment of each patient.

15. The method of claim 12, wherein said customer list comprises a list of retail stores, said product catalog comprises a catalog of retail goods, and said product ordering history record comprises a list of retail goods stocked by each retail store.

16. The method of claim 12, further comprising removing a customer from said customer list after a predetermined time period from a last placed order by said customer expires.

17. The method of claim 11, further comprising transmitting said purchase order from a portable information manager to a server via a wireless connection.

18. The method of claim 17, wherein said order is transmitted automatically when placed.

19. A program product for causing an information manager to perform the method steps of:
accessing a product order history record;
placing a purchase order;
entering a delivery address from one of an end customer delivery address, an order placer delivery address, and a delivery location other than said end customer location and said order placer location; and
shipping said product from said vendor to said entered delivery address.

20. The program product of claim 19, further performing the method step of maintaining a customer database, said database including:
a customer list;
a product catalog; and
said product ordering history record.
